(19) United States
(12) Patent Application Publication
(10) Pub. No.: US 2011/0074641 A1
(43) Pub. Date: Mar. 31, 2011

(54) MULTIPLE RESONANCE ANTENNA AND COMMUNICATION DEVICE

(75) Inventors: Naoki SOTOMA, Tokyo (JP); Noriyuki Hirabayashi, Tokyo (JP)

(73) Assignee: TDK CORPORATION, Tokyo (JP)

(21) Appl. No.: 12/880,831

(22) Filed: Sep. 13, 2010

(30) Foreign Application Priority Data
Sep. 29, 2009 (JP) 2009-225411

(51) Int. Cl. H01Q 1/38; H01Q 1/24

(52) U.S. Cl. 343/702; 343/700 MS

(57) ABSTRACT

A multiple resonance antenna includes a dielectric substrate, a first antenna electrode and a second antenna electrode, wherein the first and second antenna electrodes are disposed alongside on the dielectric substrate with first ends connected in common but with second ends remaining free, the first antenna electrode is bent back to have a greater length between the first and second ends than the second antenna electrode, and the second antenna electrode is disposed between a forward part before the bend and a backward part after the bend of the first antenna electrode.

### BACKGROUND OF THE INVENTION

1. Field of the Invention

The present invention relates to a multiple resonance antenna and a communication device using the same.

2. Description of the Related Art

A multiple resonance antenna includes two antenna electrodes of different resonance frequencies per one chip and therefore can deal with different two frequency bands even though it is a single chip. Typically, the antenna electrodes are each formed as a λ/4 monopole antenna and share a power feeding path but branch off from the power feeding path. Examples of devices to which the multiple resonance antenna is applicable include a mobile communication device having a function of GPS (global positioning system) and a function of Bluetooth (which is a registered trademark, though not mentioned again), such as a mobile phone. GPS utilizes radio waves of 1.57 GHz band, while Bluetooth utilizes radio waves of 2.45 GHz band, so that the multiple resonance antenna has to be able to deal with these frequency bands.

With the development in information technology, moreover, data to be communicated through a wireless LAN may sometimes include data with a large amount of information, such as image. Accordingly, the communication of information through the wireless LAN may use separated frequency bands such that a high-frequency band (e.g., 5.2 GHz band) with a high transmission rate is for data with a large amount of information while a low-frequency band (e.g., 2.45 GHz band) with a long communication distance is for normal data.

As a multiple resonance antenna for the above application, for example, Japanese Unexamined Patent Application Publication No. 2005-167762 discloses an antenna where a first antenna electrode for a first frequency band is disposed on a top surface of a rectangular parallelepiped dielectric substrate while a second antenna electrode for a second frequency band is disposed on a side surface of the dielectric substrate.

However, since the mobile communication devices into which the multiple resonance antenna of this type is to be incorporated are required to be much smaller and have more functionality and higher packaging density, further miniaturization is required for the multiple resonance antenna. For miniaturization, it is effective to form the dielectric substrate from a material of a high relative permittivity. This is because the electrical length of the antenna increases with increase in relative permittivity of the dielectric substrate while the physical length is constant.

However, since the multiple resonance antenna of this type has both the high-frequency antenna electrode and the low-frequency antenna electrode, if a dielectric material of a high relative permittivity is used as the dielectric substrate for the purpose of shortening the electrical length of the low-frequency antenna electrode, it also affects the high-frequency antenna electrode. More specifically, since the physical length of the high-frequency antenna electrode becomes too short, its antenna characteristics become deteriorated as compared with the low-frequency one, causing an imbalance of antenna characteristics between the low-frequency one and the high-frequency one.

This problem cannot be solved even by the technology disclosed in Japanese Unexamined Patent Application Publication No. 2005-167762. According to the configuration disclosed in Japanese Unexamined Patent Application Publication No. 2005-167762, miniaturization depends on the length of the low-frequency antenna electrode, so that it is difficult to achieve miniaturization while keeping a balance of antenna characteristics between the low-frequency one and the high-frequency one. Furthermore, since the low-frequency antenna electrode and the high-frequency antenna electrode are disposed on different planes that are inclined at 90 degrees to each other, the characteristics may be deteriorated after the antenna is mounted on a board.

### SUMMARY OF THE INVENTION

An object of the present invention is to provide a multiple resonance antenna which can keep a balance between high-frequency antenna characteristics and low-frequency antenna characteristics while achieving miniaturization.

In order to achieve the above object, a multiple resonance antenna according to the present invention comprises a dielectric substrate, a first antenna electrode and a second antenna electrode. The first and second antenna electrodes are disposed alongside on the dielectric substrate with first ends connected in common but with second ends remaining free. The first antenna electrode is bent back to have a greater length between the first and second ends than the second antenna electrode. The second antenna electrode is disposed between a forward part before the bend and a backward part after the bend of the first antenna electrode.

In the multiple resonance antenna according to the present invention, since the first and second antenna electrodes are disposed alongside on the dielectric substrate with first ends connected in common but with second ends remaining free and the first antenna electrode has a greater length between the first and second ends than the second antenna electrode, it is possible to realize a single-chip multiple resonance antenna in which the first antenna electrode serves as the low-frequency one and the second antenna electrode serves as the high-frequency one.

Moreover, since the first antenna electrode is bent back, a necessary physical length can be secured for the first antenna electrode while reducing the overall size of the dielectric substrate to achieve miniaturization as a whole.

The multiple resonance antenna according to the present invention is characterized in that the second antenna electrode is disposed between the forward part before the bend and the backward part after the bend of the first antenna electrode. With this configuration, excellent antenna characteristics can be secured while keeping a balancing of antenna characteristics between the low-frequency first antenna electrode and the high-frequency second antenna electrode.

Furthermore, since the physical length is increased by bending back the first antenna electrode, it is no more necessary to considerably increase the relative permittivity of the dielectric substrate. This also contributes to achieving a balance between the low-frequency antenna characteristics and the high-frequency antenna characteristics.

In one embodiment of the multiple resonance antenna according to the present invention, the first and second antenna electrodes are disposed on a same plane of the dielectric substrate. Alternatively, the forward part and the backward part may be disposed separately on different planes, e.g., a top surface and a side surface of the dielectric substrate.

The present invention further provides a communication device using the above-described multiple resonance antenna. This communication device includes a multiple resonance antenna, a low-frequency communication unit and a high-frequency communication unit, wherein the multiple resonance antenna is connected to the low-frequency communication unit and the high-frequency communication unit.

According to the present invention, as described above, there can be obtained the following effects:

(1) To provide a single-chip multiple resonance antenna in which a first antenna electrode serves as the low-frequency one and a second antenna electrode serves as the high-frequency one, and a communication device using the same.
(2) To provide a multiple resonance antenna in which the overall size of a dielectric substrate is reduced to achieve miniaturization as a whole, and a communication device using the same.
(3) To provide a multiple resonance antenna in which excellent antenna characteristics are secured while keeping a balance of antenna characteristics between a low-frequency first antenna electrode and a high-frequency second antenna electrode, and a communication device using the same.

The resent invention will be more fully understood from the detailed description given hereinbelow and the accompanying drawings which are given by way of illustration only, and thus not to be considered as limiting the present invention.

### BRIEF DESCRIPTION OF THE DRAWINGS

FIG. 1 is a perspective view showing one embodiment of a multiple resonance antenna according to the present invention;

FIG. 2 is a sectional view taken along line II-II in FIG. 1;

FIG. 3 is a sectional view taken along line III-III in FIG. 1;

FIG. 4 is a sectional view of a FPC which can be used for a multiple resonance antenna according to the present invention;

FIG. 5 is a perspective view showing a state where a multiple resonance antenna according to the present invention is mounted on a circuit board;

FIG. 6 is a perspective view showing another embodiment of a multiple resonance antenna according to the present invention;

FIG. 7 is a perspective view showing still another embodiment of a multiple resonance antenna according to the present invention;

FIG. 8 is simulation data showing frequency-efficiency characteristics of a low-frequency antenna electrode of a multiple resonance antenna according to the present invention in comparison with a comparative example;

FIG. 9 is simulation data showing frequency-efficiency characteristics of a high-frequency antenna electrode of a multiple resonance antenna according to the present invention in comparison with a comparative example;

FIG. 10 is a perspective view of a multiple resonance antenna that is shown as a comparative example in FIGS. 8 and 9;

FIG. 11 is a perspective view of a multiple resonance antenna that is shown as another comparative example in FIGS. 8 and 9; and

FIG. 12 is a block diagram of a communication device using a multiple resonance antenna according to the present invention.

### DESCRIPTION OF THE PREFERRED EMBODIMENTS

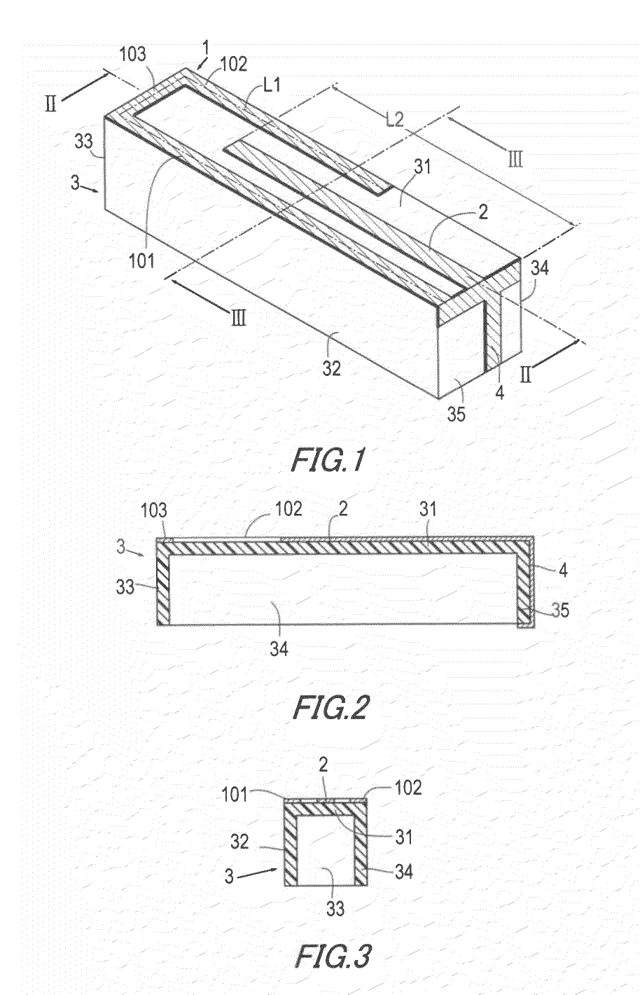

Referring first to FIG. 1, a multiple resonance antenna according to the present invention includes a first antenna electrode 1, a second antenna electrode 2 and a dielectric substrate 3. The dielectric substrate 3 is preferably made of a composite dielectric material being a mixture of a synthetic resin and dielectric ceramic powder. For example, the synthetic resin may be ABS (acrylonitrile butadiene styrene) resin or PC (polycarbonate) resin. The dielectric ceramic powder may be barium titanate series ceramic powder or titanium oxide series ceramic powder. Advantageously, the use of such a composite dielectric material makes it possible to adjust the relative permittivity of the dielectric substrate 3, form the dielectric substrate 3 into a required shape by using a molding technique, and color the dielectric substrate 3 by mixing a pigment.

The dielectric substrate 3 may have a solid block shape or a mostly hollow shape with outer wall surfaces. In this embodiment, the latter shape is chosen and embodied in an overall hexahedral shape which has a top panel 31 and four side panels 32 to 35 but is open at a bottom panel opposite to the top panel 31. However, the overall shape is not limited to the hexahedral shape. Other shapes may also be employed.

The first antenna electrode 1 and the second antenna electrode 2 are disposed alongside on the dielectric substrate 3. The first antenna electrode 1 and the second antenna electrode 2 are each formed as λ/4 monopole antenna and share a power feeding electrode 4 but branch off from the power feeding electrode 4. In this embodiment, the first antenna electrode 1 and the second antenna electrode 2 are disposed alongside on the top panel 31 of the dielectric substrate 3 while being spaced apart from each other. Of the first antenna electrode 1 and the second antenna electrode 2, first ends are connected in common, but second ends remain free. The first ends connected in common are connected to the power feeding electrode 4.

The first antenna electrode 1 has a length L1 between the first and second ends, which is greater than a length L2 of the second antenna electrode 2, and is bent back to have a forward part 101 from the first end and before the bend and a backward part 102 after the bend. The forward part 101 and the backward part 102 are continuous with each other through a bending part 103. The length L1 of the first antenna electrode 1 is a dimension measured along a centerline passing through the widthwise center.

The second antenna electrode 2 is disposed between the forward part 101 and the backward part 102 after the bend of the first antenna electrode 1. In detail, the second antenna electrode 2 is parallel to the forward part 101 of the first antenna electrode 1 at one lateral side, opposed to the bending part 103 of the first antenna electrode 1 at a tip side, and parallel to the backward part 102 of the first antenna electrode 1 at the other lateral side, wherein all the sides are spaced apart from the first antenna electrode 1.

The length L1 of the first antenna electrode 1 is determined to have an electrical length λ/4 taking into consideration its intended frequency and the relative permittivity of the dielectric substrate 3. The length L2 of the second antenna electrode 2 is determined in the same manner. For example, when the multiple resonance antenna according to the present invention is applied to a mobile communication device having a function of GPS (global positioning system) and a function of Bluetooth, such as a mobile phone, GPS utilizes radio waves of 1.57 GHz band, while Bluetooth utilizes radio waves of 2.45 GHz band. Accordingly, taking into consideration the relative permittivity of the dielectric substrate 3, the length L1 of the first antenna electrode 1 is set to a dimension corresponding to the radio waves of 1.57 GHz band for GPS, while the length L2 of the second antenna electrode 2 is set to a dimension corresponding to the radio waves of 2.45 GHz band for Bluetooth.

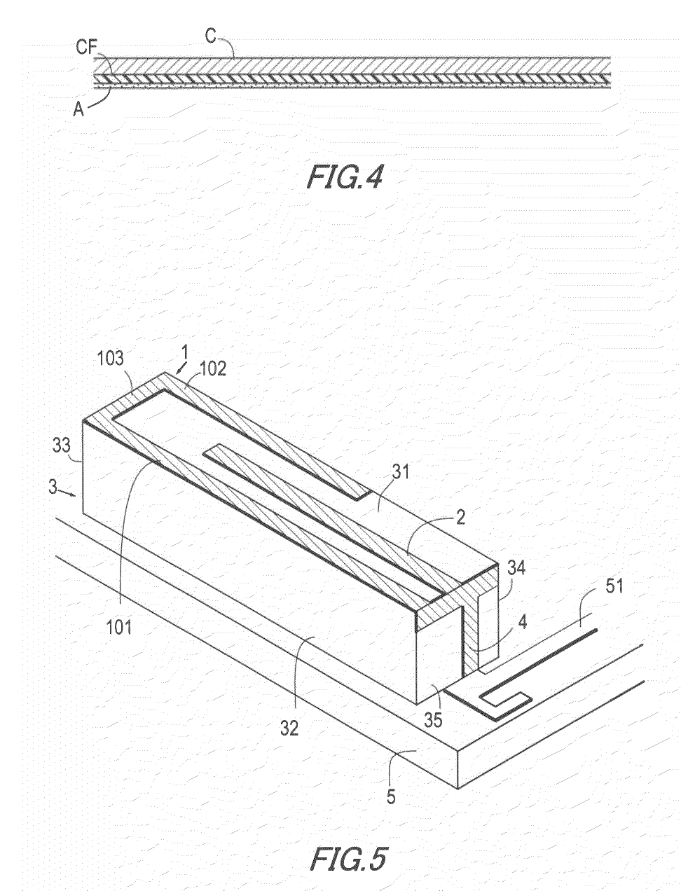

As shown in FIG. 4, preferably, the first antenna electrode 1 and the second antenna electrode 2 are supported by a flexible insulating film CF with an adhesive layer A, wherein the flexible insulating film CF is adhered onto the dielectric substrate 3 by utilizing adhesion of the adhesive layer A. On the flexible insulating film CF, there is disposed an electrode film C for serving as an antenna electrode. Concretely, a FPC (flexible printed circuits), on one surface of which the first antenna electrode 1 and the second antenna electrode 2 are formed in a predetermined pattern, is adhered to the dielectric substrate 3 by utilizing adhesion of the adhesive layer A applied to the other surface of the FPC. With this configuration, the first antenna electrode 1 and the second antenna electrode 2 can be quickly and efficiently applied to the dielectric substrate 3.

Moreover, since the first antenna electrode 1 and the second antenna electrode 2 can be formed by patterning the flexible insulating film CF, high patterning accuracy can be secured for the first antenna electrode 1 and the second antenna electrode 2.

Furthermore, since the first antenna electrode 1 and the second antenna electrode 2 are supported by the flexible insulating resin film CF, even if they are adhered to a corner or the like of the dielectric substrate 3, it will never cause a problem such as reducing the thickness of the electrode film forming the first antenna electrode 1 and the second antenna electrode 2.

In the multiple resonance antenna according to the present invention, as described above, since the first and second antenna electrodes 1, 2 are disposed alongside on the dielectric substrate 3 with first ends connected in common but with second ends remaining free and the first antenna electrode 1 has a greater length between the first and second ends than the second antenna electrode 2, it is possible to realize a single-chip multiple resonance antenna in which the first antenna electrode 1 serves as the low-frequency one and the second antenna electrode 2 serves as the high-frequency one.

Moreover, since the first antenna electrode 1 is bent back, a necessary physical length L1 can be secured for the first antenna electrode 1 while reducing the overall size of the dielectric substrate 3 to achieve miniaturization as a whole.

The multiple resonance antenna according to the present invention is characterized in that the second antenna electrode 2 is disposed between the forward part 101 before the bend and the backward part 102 after the bend of the first antenna electrode 1. With this configuration, excellent antenna characteristics can be secured while keeping a balance of antenna characteristics between the low-frequency first antenna electrode 1 and the high-frequency second antenna electrode 2. It should be noted that the antenna characteristics include transmitting and receiving characteristics.

Furthermore, since the physical length is increased by bending back the first antenna electrode 1, it is no more necessary to considerably increase the relative permittivity of the dielectric substrate 3. This also contributes to achieving a balance between the low-frequency antenna characteristics and the high-frequency antenna characteristics.

The multiple resonance antenna shown in FIGS. 1 to 3 is mounted with the bottom of the dielectric substrate 3 opposed to one surface of a circuit board 5, as shown in FIG. 5. Then, the power feeding electrode 4 is connected to a conductive pattern 51 on the circuit board 5. The side panel 32 is located close to an edge (corner) of the circuit board 5, and electronic components are usually mounted on the side of the side panel 34, so that the side panel 32 is directed to a surface where no electronic component is mounted and serves as an open board surface.

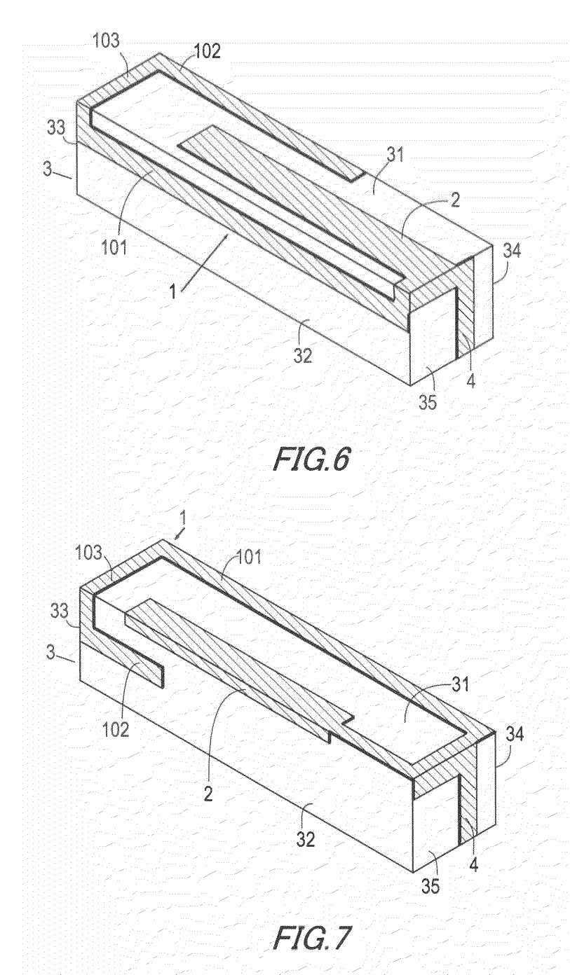

In the multiple resonance antenna shown in FIGS. 1 to 3, the first antenna electrode 1 and the second antenna electrode 2 are disposed on the same plane of the dielectric substrate 3. Alternatively, the forward part 101 and the backward part 102 may be disposed on different planes, e.g., a top surface and a side surface of the dielectric substrate 3. Such an embodiment is shown in FIGS. 6 and 7.

Referring first to FIG. 6, the first antenna electrode 1 and the second antenna electrode 2 have the same characteristic features as in the embodiment shown in FIGS. 1 to 3. Therefore, it has similar effects to the embodiment shown in FIGS. 1 to 3.

In the embodiment shown in FIG. 6, the forward part 101 of the first antenna electrode 1 is disposed on the side panel 32 that is perpendicular to the top panel 31 having the second antenna electrode 2, unlike in the embodiment shown in FIGS. 1 to 3. When the multiple resonance antenna is mounted on the circuit board 5, as shown in FIG. 5, the surface of the side panel 32 serves as an open board surface. With this structure, it is possible to improve the antenna characteristics (radiation characteristics) of the high-frequency second antenna electrode 2.

The first antenna electrode 1 extends from the side panel 32 to the top panel 31 to have the backward part 102 on the top panel 31 and therefore passes through a corner of the side panel 32 and the top panel 31. It should be noted that if the first antenna electrode 1 and the second antenna electrode 2 are supported by the flexible insulating film CF with the adhesive layer A, as has been described with reference to FIG. 4, it will never cause a problem such as reducing the thickness of the electrode film forming the first antenna electrode 1 and the second antenna electrode 2.

Referring next to FIG. 7, the backward part 102 of the first antenna electrode 1 is disposed on the side panel 32 that is perpendicular to the top panel 31 having the second antenna electrode 2, unlike in the embodiment shown in FIGS. 1 to 3. Thus, the tip of the backward part 102 of the first antenna electrode 1 also lies on the side panel 32 serving as an open board surface. With this structure, it is possible to improve the antenna characteristics (radiation characteristics) of the low-frequency first antenna electrode 1.

A half of the width of the second antenna electrode 2 is disposed on the top panel 31, and the rest is disposed on the side panel 32. The vicinity of widthwise center of the second antenna electrode 2 lies on the corner of the top panel 31 and the side panel 32. It should be noted that if the first antenna electrode 1 and the second antenna electrode 2 are supported by the flexible insulating film CF with the adhesive layer A, as shown in FIG. 4, it will never cause a problem such as reducing the thickness of the electrode film forming the first antenna electrode 1 and the second antenna electrode 2.

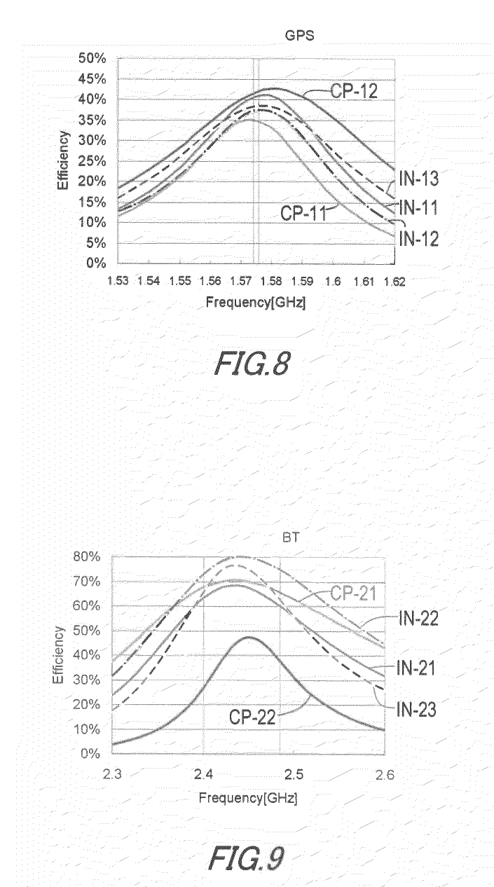

Referring next to the simulation data shown in FIGS. 8 and 9, frequency-efficiency characteristics of the multiple resonance antenna according to the present invention will be described in comparison with those of comparative examples (prior art examples). In FIGS. 8 and 9, the frequency (GHz) is plotted in abscissa and the efficiency (%) is plotted in ordinate. The shown efficiency is radiation efficiency but is also reflected in reception efficiency.

FIGS. 8 and 9 are the simulation data on the assumption that the multiple resonance antenna according to the present invention is applied to a mobile communication device (e.g., mobile phone) having a function of GPS and a function of Bluetooth. GPS utilizes radio waves of 1.57 GHz band, while Bluetooth utilizes radio waves of 2.45 GHz band. Thus, the first antenna electrode 1 (the low-frequency one) relates to GPS, while the second electrode 2 (the high-frequency one) relates to Bluetooth. Of FIGS. 8 and 9, FIG. 8 shows the characteristics of the first antenna electrode 1 relating to GPS, while FIG. 9 shows the characteristics of the second antenna electrode 2 relating to Bluetooth.

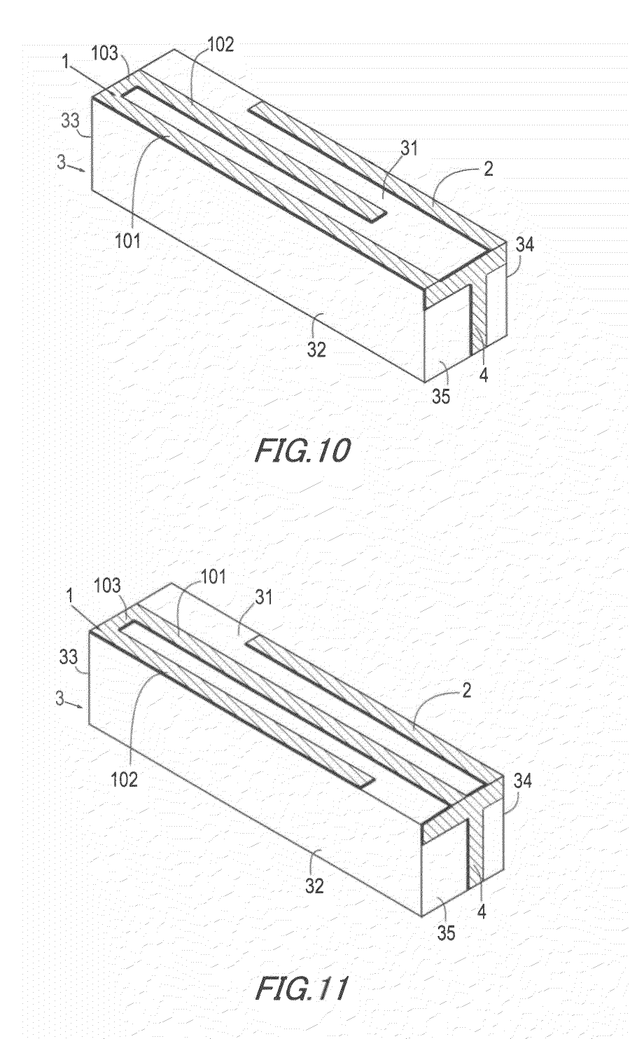

In FIG. 8, at first, the curve IN-11 represents the antenna characteristics of the first antenna electrode 1 in the multiple resonance antenna shown in FIGS. 1 to 3, the curve IN-12 represents the antenna characteristics of the first antenna electrode 1 in the multiple resonance antenna shown in FIG. 6, and the curve IN-13 represents the antenna characteristics of the first antenna electrode 1 in the multiple resonance antenna shown in FIG. 7. The curve CP-11 represents the antenna characteristics of the first antenna electrode 1 in a multiple resonance antenna shown in FIG. 10, and the curve CP-12 represents the antenna characteristics of the first antenna electrode 1 in a multiple resonance antenna shown in FIG. 11.

In FIG. 9, on the other hand, the curve IN-21 represents the antenna characteristics of the second antenna electrode 2 in the multiple resonance antenna shown in FIGS. 1 to 3, the curve IN-22 represents the antenna characteristics of the second antenna electrode 2 in the multiple resonance antenna shown in FIG. 6, and the curve IN-23 represents the antenna characteristics of the second antenna electrode 2 in the multiple resonance antenna shown in FIG. 7. The curve CP-21 represents the antenna characteristics of the second antenna electrode 2 in the multiple resonance antenna shown in FIG. 10, and the curve CP-22 represents the antenna characteristics of the second antenna electrode 2 in the multiple resonance antenna shown in FIG. 11.

The multiple resonance antennas shown in FIGS. 10 and 11 are identical to the multiple resonance antenna according to the present invention in that the first antenna electrode 1 has the forward part 101, the bending part 103, and the backward part 102, but decisively different from the multiple resonance antenna according to the present invention in that the second antenna electrode 2 is disposed not between the forward part 101 and the backward part 102 of the first antenna electrode 1 but outside the backward part 102 (FIG. 10) or outside the forward part 101 (FIG. 11).

For the simulation, the dielectric substrate 3 was prepared to have a length of 16 mm, a width of 5 mm, a height of 5 mm, and a relative permittivity of 6.0. Moreover, the first and second antenna electrodes 1, 2 were formed from a FPC.

Referring first to FIG. 8, within the GPS frequency band of 1.57 to 1.58 GHz, the multiple resonance antenna according to the present invention has an efficiency of about 41% for the characteristics IN-11, about 37.5% for the characteristics IN-12 and about 38% for the characteristics IN-13. On the other hand, within the GPS frequency band of 1.57 to 1.58 GHz, the multiple resonance antenna for comparison has an efficiency of about 35% for the characteristics CP-11 and about 43% for the characteristics CP-12.

Referring next to FIG. 9, within the Bluetooth frequency band of 2.4 to 2.5 GHz, the multiple resonance antenna according to the present invention has an efficiency of about 69% for the characteristics IN-21, about 80% for the characteristics IN-22 and about 75% for the characteristics IN-23. On the other hand, within the Bluetooth frequency band of 2.4 to 2.5 GHz, the multiple resonance antenna for comparison has an efficiency of about 70% for the characteristics CP-21 and about 48% for the characteristics CP-22.

A summary of the above results is as follows.

### (Concerning the Multiple Resonance Antenna of the Present Invention)

(1) The multiple resonance antenna shown in FIGS. 1 to 3

The first antenna electrode 1 has an efficiency of about 41% (the characteristics IN-11 in FIG. 8).

The second antenna electrode 2 has an efficiency of about 69% (the characteristics IN-21 in FIG. 9).

(2) The multiple resonance antenna shown in FIG. 6

The first antenna electrode 1 has an efficiency of about 37.5% (the characteristics IN-12 in FIG. 8).

The second antenna electrode 2 has an efficiency of about 80% (the characteristics IN-22 in FIG. 9).

(2) The multiple resonance antenna shown in FIG. 7

The first antenna electrode 1 has an efficiency of about 38% (the characteristics IN-13 in FIG. 8).

The second antenna electrode 2 has an efficiency of about 75% (the characteristics IN-23 in FIG. 9).

### (Concerning the Multiple Resonance Antenna for Comparison)

(1) The multiple resonance antenna shown in FIG. 10

The first antenna electrode 1 has an efficiency of about 35% (the characteristics CP-11 in FIG. 8).

The second antenna electrode 2 has an efficiency of about 70% (the characteristics CP-21 in FIG. 9).

(2) The multiple resonance antenna shown in FIG. 11

The first antenna electrode 1 has an efficiency of about 43% (the characteristics CP-12 in FIG. 8).

The second antenna electrode 2 has an efficiency of about 48% (the characteristics CP-22 in FIG. 9).

In general, the practical requirements are such that for GPS, the efficiency should be equal to or greater than 37%, while for Bluetooth, the efficiency should be equal to or greater than 50%, so that it is essential for products to satisfy these requirements. However, in the case of the multiple resonance antenna of FIG. 10 for comparison, the efficiency of the first antenna electrode 1 is about 35% and fails to satisfy the above requirement, and in the case of the multiple resonance antenna of FIG. 11, the efficiency of the second antenna electrode 2 is about 48% and fails to satisfy the above requirement.

On the other hand, the multiple resonance antenna according to the present invention satisfies the above practical requirements. That is, the prior art has an imbalance of antenna characteristics between the low-frequency one and the high-frequency one, but the present invention can solve this problem.

Furthermore, in the case of the multiple resonance antenna of FIG. 6, the efficiency of the high-frequency second antenna electrode 2 is about 80% (the characteristics IN-22 in FIG. 9), and in the case of the multiple resonance antenna of FIG. 7, the efficiency of the high-frequency second antenna electrode 2 is about 75% (the characteristics IN-23 in FIG. 9), which means that the efficiency of the high-frequency second antenna electrode 2 is improved in both cases.

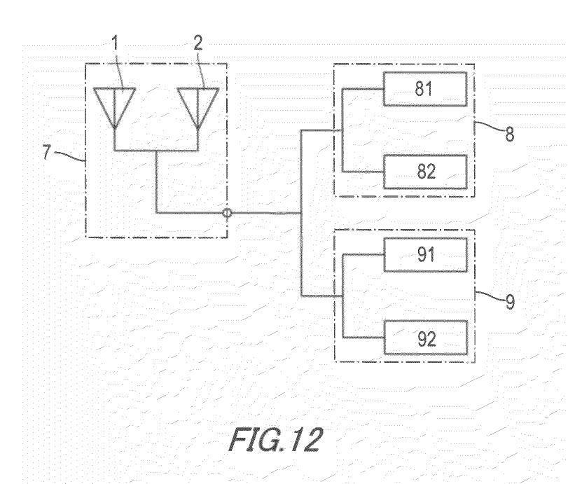

The present invention further provides a communication device using the above-described multiple resonance antenna. FIG. 12 shows one embodiment. The illustrated communication device includes a multiple resonance antenna 7 according to the present invention, a low-frequency communication unit 8 and a high-frequency communication unit 9.

The multiple resonance antenna 7 includes the first antenna electrode 1 and the second antenna electrode 2. Details are the same as described above. The power feeding path of the multiple resonance antenna 7 is connected to an input-output side of the low-frequency communication unit 8 and the high-frequency communication unit 9. For example, the low-frequency communication unit 8 has a function of GPS, while the high-frequency communication unit 9 has a function of Bluetooth. It should be noted that “low-frequency” and “high-frequency” are relative expression. The low-frequency communication unit 8 has a transmitting circuit 81 and a receiving circuit 82, and the high-frequency communication unit 9 has a transmitting circuit 91 and a receiving circuit 92. Although not shown in the figure, of course, circuit elements necessary for a communication device of this type should be added thereto.

While the present invention has been particularly shown and described with respect to preferred embodiments thereof, it will be understood by those skilled in the art that various changes in form and detail may be made therein without departing from the spirit, scope and teaching of the invention.

What is claimed is:

1. A multiple resonance antenna comprising a dielectric substrate, a first antenna electrode and a second antenna electrode, wherein
the first and second antenna electrodes are disposed alongside on the dielectric substrate with first ends connected in common but with second ends remaining free,
the first antenna electrode is bent back to have a greater length between the first and second ends than the second antenna electrode, and
the second antenna electrode is disposed between a forward part before the bend and a backward part after the bend of the first antenna electrode.

2. The multiple resonance antenna of claim 1, wherein the first and second antenna electrodes are disposed on a same plane of the dielectric substrate.

3. The multiple resonance antenna of claim 1, wherein the forward part and the backward part are disposed on different planes of the dielectric substrate.

4. The multiple resonance antenna of claim 1, wherein the dielectric substrate is made of a composite dielectric material containing a synthetic resin and ceramic powder.

5. The multiple resonance antenna of claim 1, wherein the first and second antenna electrodes are supported by an adhesive, flexible insulating film, and the flexible insulating film is adhered onto the dielectric substrate.

6. A communication device comprising a multiple resonance antenna, a low-frequency communication unit and a high-frequency communication unit, wherein
the multiple resonance antenna includes a dielectric substrate, a first antenna electrode and a second antenna electrode,
the first and second antenna electrodes are disposed alongside on the dielectric substrate with first ends connected in common but with second ends remaining free,
the first antenna electrode is bent back to have a greater length between the first and second ends than the second antenna electrode,
the second antenna electrode is disposed between a forward part before the bend and a backward part after the bend of the first antenna electrode, and
the low-frequency and high-frequency communication units are connected to the multiple resonance antenna.

7. The communication device of claim 6, wherein the first and second antenna electrodes are disposed on a same plane of the dielectric substrate.

8. The communication device of claim 6, wherein the forward part and the backward part are disposed on different planes of the dielectric substrate.

9. The communication device of claim 6, wherein the dielectric substrate is made of a composite dielectric material containing a synthetic resin and ceramic powder.

10. The communication device of claim 6, wherein the first and second antenna electrodes are supported by an adhesive, flexible insulating film, and the flexible insulating film is adhered onto the dielectric substrate.
